(19) United States
(12) Patent Application Publication
(10) Pub. No.: US 2012/0201379 A1
(43) Pub. Date: Aug. 9, 2012

(54) METHOD AND APPARATUS FOR PROTECTING SECURITY PARAMETERS USED BY A SECURITY MODULE

(75) Inventors: KENNETH C. FUCHS, WINFIELD, IL (US); TOMASZ PALARZ, PALOS PARK, IL (US)

(73) Assignee: MOTOROLA SOLUTIONS, INC., Schaumburg, IL (US)

(21) Appl. No.: 13/020,952

(22) Filed: Feb. 4, 2011

(51) Int. Cl. H04K 1/00

(52) U.S. Cl. 380/255

(57) ABSTRACT

A security module includes non-volatile memory, a key protection key generator, and volatile memory. The security module performs a method for protecting security parameters that includes: storing a secret key in the non-volatile memory, wherein the secret key is unique to the security module; applying a key split algorithm to a plurality of key split components to generate a key protection key, wherein the plurality of key split components includes the secret key; decrypting an encrypted first key using the key protection key; performing at least one of media encryption or media decryption using the decrypted first key; storing the key protection key and the decrypted first key in volatile memory.

### TECHNICAL FIELD

The present disclosure relates generally to communication devices and in particular to a method and apparatus for protecting security parameters used by a security module for a communication device.

### BACKGROUND

In some scenarios, such as public safety for instance, there is need for secure communications such as by providing encrypted voice calls for communication devices. In one use case scenario, a mobile device such as a mobile phone, cellular phone, or smart phone has a slot, opening, or aperture that is adapted to receive a stand-alone security module that is used to provide encryption and decryption of media for the communication device. The security module uses various security parameters to provide for the data encryption and decryption, and secure communications for the communication device are compromised if the security parameters are not properly protected.

Accordingly, what is needed is a method for protecting security parameters used by a security module for a communication device.

### BRIEF DESCRIPTION OF THE FIGURES

The accompanying figures, where like reference numerals refer to identical or functionally similar elements throughout the separate views, together with the detailed description below, are incorporated in and form part of the specification and serve to further illustrate various embodiments of concepts that include the claimed invention, and to explain various principles and advantages of those embodiments.

FIG. 1 is a block diagram illustrating a security module in accordance with various embodiments.

FIG. 2 is a flow diagram illustrating a method for protecting security parameters used by a security module in accordance with various embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, a security module includes non-volatile memory, a key protection key generator, a cipher block, and volatile memory. The security module performs a method for protecting security parameters that it uses, which includes: storing a secret key in the non-volatile memory, wherein the secret key is unique to the security module; applying a key split algorithm to a plurality of key split components to generate a key protection key, wherein the plurality of key split components includes the secret key; decrypting an encrypted first key using the key protection key; performing at least one of media encryption or media decryption using the decrypted first key; storing the key protection key and the decrypted first key in volatile memory.

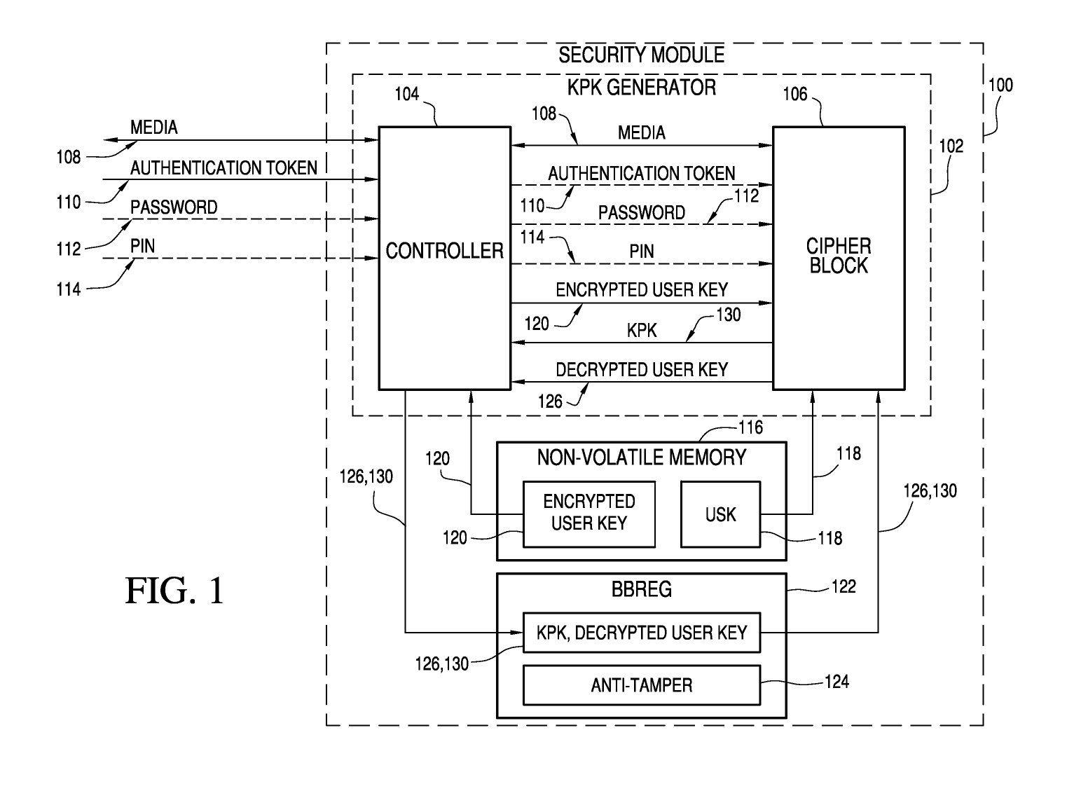

Referring now to the figures, FIG. 1 illustrates a security module 100 in accordance with various embodiments. Security module 100 comprises a key protection key (KPK) generator 102, non-volatile memory (NVM) 116, and volatile memory (VM) 122. The KPK generator, in turn, includes a controller 104 and a cipher block 106. In an illustrative implementation, the cipher block 106 is a dedicated piece of encoded hardware (i.e., hardware that is encoded with processing instructions) within the KPK generator 102 that provides for one or more cryptographic functions under the control of the controller 104. The controller 104 is a block of firmware that provides inputs and control signals, for instance, to the cipher block 106.

In an embodiment, the security module 100 is for use by a communication device (also referred to herein as a host communication device and not shown), such as a mobile device, for encrypting and decrypting media for the communication device. The communication device can be any type of communication device such as a radio, a mobile phone, a mobile data terminal, a Personal Digital Assistant (PDA), a smart phone, a laptop, a two-way radio, a cell phone, and any other mobile device capable of operating in a wired or wireless environment.

For example, the communication device has a slot, opening, or aperture that is adapted (e.g., sized and shaped) to receive the security module, which is a stand-alone security module used by the communication device for encrypting media (e.g., voice, data, etc.) that it sends to another device or decrypting media that the communication device receives from another device. By stand-alone, what is meant herein is that the security module comprises a removable piece of hardware (e.g., having one or more integrated circuit or chips) within a suitable housing that is separate from the communication device housing and separate from any processing performed by hardware and software elements of the communication device. For instance, upon inserting the security module, the communication device provides for encrypting and decrypting media, and when the security module is removed, the communication device sends the media in the clear.

In one illustrative embodiment, the security module has a micro Secure Digital (uSD) format developed by the SD Card Association for use in portable devices and is characterized by dimensions of 15×11×1.0 mm. Having a uSD format means that the security module fits into and can communicate using the physical interface of a slot on a mobile device for a non-volatile memory uSD card. However, in alternative embodiments, the security module may have a standard SD format (having dimensions 32×24×2.1 mm), a miniSD format (having dimensions of 21.5×20×1.4 mm), a MultiMediaCard (MMC) format, etc.

Turning now to a description of the elements of the security module 100 shown in FIG. 1. As mentioned above, the security module 100 includes the KPK 102. In one illustrative embodiment, the KPK generator 102 can be said to be an “Advanced Encryption Standard (AES) processing block” meaning that it is programmed (in this case hardware-encoded) with at least one cipher (or other algorithm) and uses at least one symmetric key that is compliant with the AES, which is a symmetric-key encryption standard that was announced by National Institute of Standards and Technology (NIST) as U.S. FIPS PUB 197 (FIPS 197) on Nov. 26, 2001 and was adopted by the United States (US) government on May 26, 2002. As used herein, an AES key means a key that is compliant with the AES, and an AES algorithm or cipher means an algorithm or cipher that is compliant with the AES. In alternative embodiments, the KPK generator 102 is hardware-encoded with any suitable standard or proprietary algorithms and/or ciphers and uses any suitable keys for implementing its functionality. In this illustrative AES implementation, the controller 104 receives at least one key split components, which it provides to the cipher block 106 along with an instruction (e.g., an explicit instruction in the form of a digital signal or control word or an implicit instruction in the form of the provision of certain inputs needed to perform a desired processing function) to generate a KPK 130. The cipher block 106 is hardware encoded with and comprises an AES key split algorithm that receives the one or more key split components from the controller 104 along with a unique secret key 118 (which is described in more detail below) as another key split component and combines the plurality of key split components using a mathematical function or operation to generate the KPK 130. The cipher block 106 further comprises a hardware encoded cipher or “cryptographic algorithm” that is AES compliant and that is used for encrypting media 108 (i.e. converting plain text into ciphertext) that the host communication device transmits and decrypting media 108 (converting ciphertext into plain text) that the host communication device receives. Being AES compliant, the cipher comprises a 128-bit block cipher, i.e., AES-128, AES-192, or AES-256, which, respectively, symmetric key sizes of 128, 192, or 256 bit.

The non-volatile memory 116 by definition means a memory device that can retain stored information even when not powered, as compared to a volatile memory that requires power to maintain the stored information. At least a portion of the non-volatile memory 116 (i.e., the portion that holds a unique secret key) is hardware enforced, one-time writable (also referred to as one-time programmable or “OTP”) and is unreadable by a processor that executes software or firmware, which means that at least some of the items stored in the non-volatile memory 116 can only be written to the memory once, are not unreadable by a processor that executes software or firmware (such as a digital signal processor (DSP) or microprocessor) but are only selectable by one or more of the hardware blocks within the security module 100; wherein code is programmed in the hardware of the security module (e.g., within the NVM 116) to enforce this rule on unreadability by a processor.

The non-volatile memory 116 stores a unique secret key (USK) 118 and an encrypted user key 120, which is retained in the NVM 116 even when the security module 100 is not powered. Although logically shown as one physical NVM, it should be realized that the NVM can comprise a single NVM or multiple NVMs for separately storing the USK 118 and the encrypted user key 120. The USK is a value that is programmed into each security module during initial (e.g., factory) programming, for instance, and comprises a random value that is unique to each security module. During factory programming, the USK 118 is loaded into the NVM 116, into the portion of the NVM 116 that can only be written one time, wherein there exists hardware to enforce this rule.

Furthermore, the USK 118 comprises an AES key that can only be used by the cipher block 106 on the security module 100; the USK 118 value cannot be read out by any software or firmware encoded processor but can only be “selected” by the cipher block 106 for use; and there exists hardware coding on the security module 100 to enforce this rule. The VM 122 in this illustrative implementation is a battery backed register (BBREG), which is a volatile memory that has active tamper protection elements 124, described in more detail below. The BBREG 122 stores the KPK 130 and a decrypted user key 126.

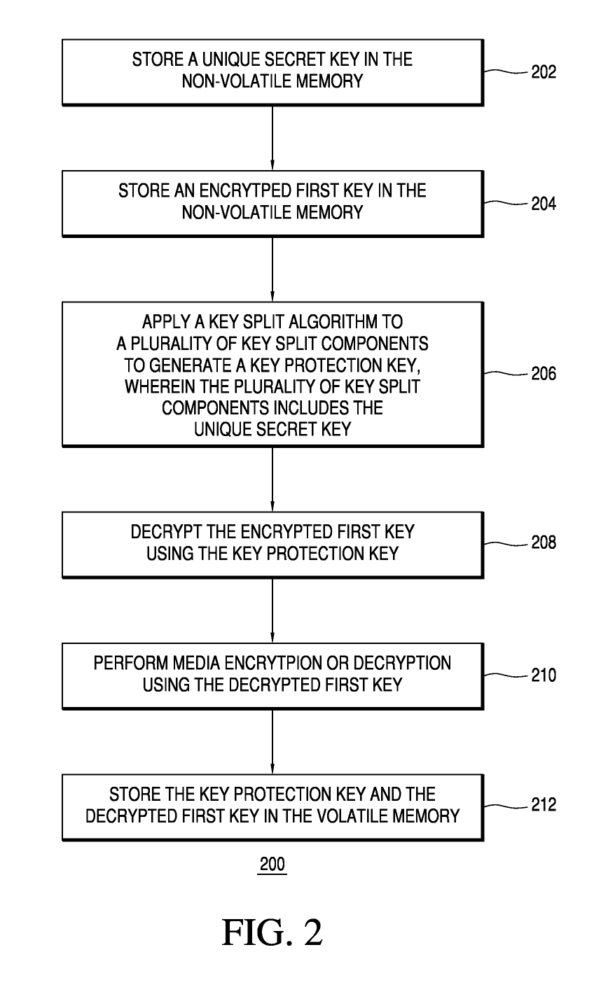

In one illustrative embodiment, the security module 100 operates to perform a method 200 illustrated by reference to FIG. 2 for protecting, in accordance with the present teachings, security parameters that it uses to facilitate the encryption and decryption of media for the host communication device. These security parameters comprise, for example, the keys used within or generated by the security module 100 including, not by way of limitation, the USK, the user key, and the KPK.

In accordance with method 200, the security module 100 stores (202, 204) both the USK (i.e. the secret key unique to the security module) and the encrypted user key (also referred to herein as the encrypted first key) in the NVM 116. The controller receives one or more key split components including, but not limited to, an authentication token 110, a password 112, or a Personal Identification Number (PIN) 114. The controller provides the at least one key split component to the cipher block 106 also with an implicit or explicit instruction to generate the KPK. The cipher block 106 reads or retrieves the USK 118 from the NVM 116 and applies (206) the split key algorithm to a plurality of key split components to generate the KPK 130, wherein the plurality of key split components includes at least the USK 118 and further includes the one or more key split components provided by the controller 104.

For example, the plurality of key split components further includes one or more of the user authentication or security token entry 110 from a user of the host communication device, the user password entry 112, or the user PIN entry 114 or some modified version of one or more of these inputs. For example, the user password and/or PIN is selected by the user or pseudo-randomly generated. Moreover, the user authentication token can be entered from a hardware device such as a key fob that randomly generates an access code (the authentication token entry) for the user. For instance, the user first authenticates himself on the key fob with a PIN, and the key fob generates the authentication token entry 110. In one illustrative implementation, the key split algorithm receives two key split components, which are used to generate the KPK. For instance, the key split components include the USK and the user password 112 or some modification of the user password (still considered as the user password for purposes of this disclosure). More particularly, in an example implementation, the controller 104 provides to the cipher block 106 a hashed version of the password that is padded out, and the cipher block 106 encrypts the hashed password with the USK using the following function (KPK=E(USK)[H[password∥pad]](255 . . . 0)) in order to generate the KPK, which the cipher block 106 outputs to the controller.

In yet another illustrative implementation, the key split algorithm requires at least three key split components, e.g., the USK 118, the authentication token entry 110, and one or both of the user password entry 112 or the PIN entry 114. Accordingly, the key split algorithm uses any suitable mathematical function to combine the USK 118, the authentication token entry 110, the password entry 112, and/or the PIN entry 114 to generate the KPK. Requiring the unique AES key (i.e., the USK 118) stored in the hardware enforced NVM 116 that is one-time writable and unreadable by a processor and requiring a total at least three key split components significantly decreases the likelihood that the KPK could be inappropriately regenerated.

The cipher block 106 further receives the encrypted user key 120 from the controller 104 (which was obtained by the controller from the NVM 116) along with an implicit or explicit instruction to decrypt the user key; decrypts (208) the user key with the KPK; and outputs the decrypted user key 126 to the controller 104. Upon instruction from the controller and provision by the controller of the media 108, the cipher block 106 performs (210) the media encryption and/or media decryption using the decrypted user key. The controller 104 stores (212) the KPK 130 and the decrypted user key 126 in the BBREG 122 while these keys are being used. More particularly, in one illustrative implementation, the KPK is generated each time the communication device establishes a communication session (e.g., using a session control protocol like Datagram Transport Layer Security (DTLS) protocol or some other session control protocol) and is used to decrypt the user key. Upon the ending of the session, the KPK 130 and the decrypted user key 126 are erased from the BBREG 122.

The BBREG 122 includes one or more hardware anti-tamper elements 124 to protect the KPK 130 and the user key 126 while it is in the clear. Any suitable hardware tamper protection can be used that erase the contents stored on the BBREG 122 in the case of tampering in an attempted to gain unauthorized access to the KPK 130 and the decrypted user key 126. Such tamper protection includes one or more of the following: an over/under voltage sensor; an over/under temperature sensors; a power sensor, an over/under frequency sensor; or an active perimeter shield.

In one example implementation, the security module has one or more voltage sensors that trip if the chip is operating outside of specified voltage limits. There can also be one or more temperature sensors that trip if the security module 100 is operating outside of specified temperature limits. There can further be frequency sensors that trip if a system clock (not shown) used by the security module is operating outside of specified frequency limits. Additionally, there may exist an active perimeter shield on the security module such that if it is breached, the BBREG 122 is erased. In one illustrative implementation, the perimeter shield is comprised of a series of metal traces that are periodically tested for conductivity. If any of the traces has been cut, the BBREG erase procedure would be initiated.

Thus, in accordance with the disclosed teachings a security module for a host communication device protects the security parameters that it uses in order to provide secure communications for the host communication device.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed. Also, the sequence of steps in a flow diagram or elements in the claims, even when preceded by a letter does not imply or require that sequence.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for protecting security parameters used by a security module, the method comprising:
the security module performing
storing a secret key in non-volatile memory, wherein the secret key is unique to the security module;
applying a key split algorithm to a plurality of key split components to generate a key protection key, wherein the plurality of key split components includes the secret key;
decrypting an encrypted first key using the key protection key;
performing at least one of media encryption or media decryption using the decrypted first key;
storing the key protection key and the decrypted first key in volatile memory.

2. The method of claim 1, wherein the plurality of key split components comprises at least three key split components.

3. The method of claim 1, wherein the plurality of key split components further comprises a user authentication token entry.

4. The method of claim 1, wherein the plurality of key split components further comprises a user Personal Identification Number entry.

5. The method of claim 1, wherein the plurality of key split components further comprises a user password entry.

6. The method of claim 1, wherein storing the secret key in non-volatile memory comprises storing the secret key in a hardware enforced non-volatile memory that is one-time writable and unreadable by a processor.

7. The method of claim 1, wherein storing the key protection key and the decrypted first key in volatile memory comprises storing the key protection key and the decrypted first key in a battery backed register having anti-tamper protection.

8. The method of claim 1 further comprising storing the encrypted first key in the non-volatile memory.

9. A security module comprising:
non-volatile memory having stored thereon a secret key that is unique to the security module;
a key protection key generator for:
receiving as input a plurality of key split components comprising the secret key and at least one of a user authentication token entry, a user Personal Identification Number entry or a user password entry;
generating a key protection key that is used to decrypt an encrypted first key; and
performing at least one of media encryption or media decryption using the decrypted first key;
volatile memory having stored thereon the key protection key and the decrypted first key.

10. The security module of claim 9, wherein the non-volatile memory comprises a hardware enforced non-volatile memory that is one-time writable and unreadable by a processor.

11. The security module of claim 9, wherein the volatile memory comprises a battery backed register having anti-tamper protection.

12. The security module of claim 9, wherein the anti-tamper protection comprises at least one of: a power sensor, a voltage sensor; a temperature sensor; a frequency sensor; or an active tamper shield.

13. The security module of claim 9, wherein the secret key is an Advanced Encryption Standard key, and the key protection key generator comprises an Advanced Encryption Standard key split algorithm used to generate the key protection key.

14. The security module of claim 9, wherein the security module is included in a mobile device.

15. The security module of claim 9, wherein the plurality of key split components comprises at least three key split components.
